(19) United States
(12) Patent Application Publication
(10) Pub. No.: US 2016/0085766 A1
(43) Pub. Date: Mar. 24, 2016

(54) COMPACTING DATA BASED ON DATA CONTENT

(71) Applicant: LONGSAND LIMITED, Cambridge (GB)

(72) Inventors: Harsha Raghavendra Kushtagi, Bangalore, Karnataka (IN); Reuti Raman Babu, Bangalore, Karnataka (IN); Srikanth Jasti, Bangalore, Karnataka (IN)

(21) Appl. No.: 14/782,981

(22) PCT Filed: Apr. 17, 2013
(86) PCT No.: PCT/EP2013/058025

§ 371 Date: Oct. 7, 2015

(51) Int. Cl. G06F 17/30

(52) U.S. Cl. CPC G06F 17/30138; G06F 17/30371; G06F 17/30082; G06F 17/30076

(57) ABSTRACT

An example method for data compaction is disclosed in accordance with an aspect of the present disclosure. The method may include receiving, at a computing device, data files associated with an account. The method may also include determining, by the computing device, whether the account has expired. The method may also include, in response to determining that the account has expired, compacting, by the computing device, the data files associated with the account based on the content of the data files.

### BACKGROUND

Users of computer systems may desire to back-up the users' data on data storage servers. Frequently, the users utilize third-party pay-for-storage companies to back-up the users' data on the storage companies' data storage servers. These third-party pay-for-storage companies may manage large volumes of data for many users. Similarly, companies may accrue large volumes of data themselves by backing-up their own data on their own servers.

### BRIEF DESCRIPTION OF THE DRAWINGS

The following detailed description references the drawings, in which:

FIG. 1 illustrates a block diagram of a computing system for compacting data based on data content according to examples of the present disclosure;

FIG. 2 illustrates a method of compacting data based on data content according to examples of the present disclosure; and

FIG. 3 illustrates a method of compacting data based on data content according to examples of the present disclosure.

### DETAILED DESCRIPTION

A company that specializes in storing large amounts of data for its customers may desire to maximize its data storage abilities while reducing or eliminating lower priority or unused data or data for which a customer is no longer paying to store. Similarly, companies that maintain their own data backups may wish to reduce data storage requirements by deleting or reducing older data. One solution is simply to delete data after a certain time. However, this solution fails to retain high-value or important data, or data which is otherwise desired to be retained. Given the challenges in today's world of collecting data, simply deleting the data may not add value to having collected the data in the first place.

Data storage companies therefore may desire a solution that allows for the intelligent reduction and deletion of data. For example, data storage companies may wish to reduce and delete data associated with an expired customer account intelligently in order to reduce the amount of storage space needed to store the data. Doing so may allow the company to free up valuable storage space while maintaining high-value data. This may be particularly useful if the customer later decides to reactivate the customer's account. Moreover, laws and regulations may require certain types of data to be maintained even after the customer account expires. Others with data storage needs may also benefit from the techniques of the present disclosure.

Various embodiments will be described below by referring to several examples of data compaction based on data content, which allow for the intelligent reduction and deletion of data. This approach to data compaction examines the content and/or file type of the data to determine intelligently whether the data should be kept, altered (e.g., compressed, converted to a different file or data type, etc.), or deleted.

In some implementations, intelligently reducing and deleting data through data compaction based on data content allows for the effective utilization of storage systems. In another example, allowing for the customization of the data compaction process provides system administrators with an alternative option to deleting or purging all the data. The techniques described herein may also enable system administrators to implement data compaction quickly by using predetermined data compaction policies. These and other advantages will be apparent from the description that follows.

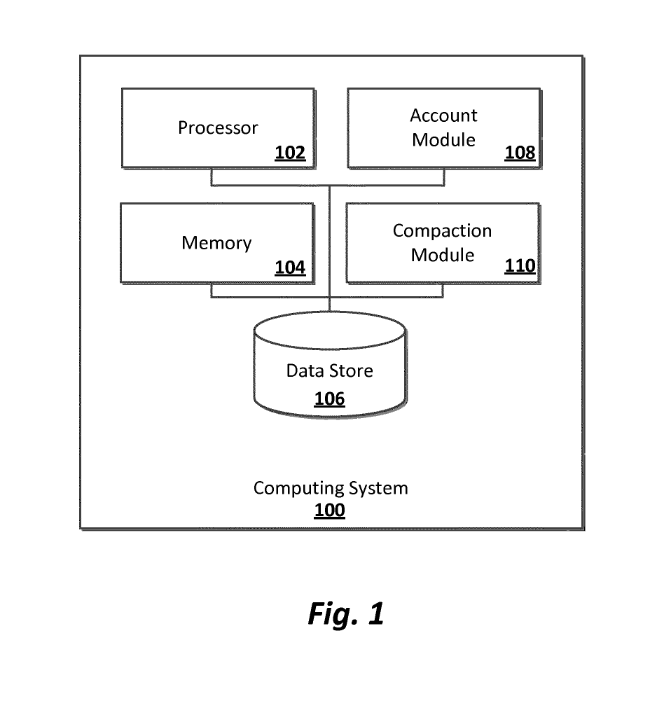

FIG. 1 illustrates a block diagram of a computing system 100 for compacting data based on data content according to examples of the present disclosure. It should be understood that the computing system 100 may include any appropriate type of computing device, including for example smartphones, tablets, desktops, laptops, workstations, servers, or the like.

As shown, the example computing system 100 may include a processor 102, a memory 104, a data store 106, an account module 108, and a compaction module 110. It should be understood that the components shown here are for illustrative purposes and that, in some cases, the functionality being described with respect to a particular component may be performed by one or more different or additional components. Similarly, it should be understood that portions or all of the functionality may be combined into fewer components than are shown.

The processor 102 may be configured to process instructions for execution by the computing system 100. The instructions may be stored on a non-transitory tangible computer-readable storage medium, such as in the memory 104 or on a separate device (not shown), or on any other type of volatile or non-volatile memory that stores instructions to cause a programmable processor to perform the techniques described herein. Alternatively or additionally, the example computing system 100 may include dedicated hardware, such as one or more integrated circuits, Application Specific Integrated Circuits (ASICs), Application Specific Special Processors (ASSPs), Field Programmable Gate Arrays (FPGAs), or any combination of the foregoing examples of dedicated hardware, for performing the techniques described herein. In some implementations, multiple processors may be used, as appropriate, along with multiple memories and/or types of memory.

The data store 106 of the example computing system 100 may contain user data. In one example, the data store 106 may be a hard disk drive or a collection of hard disk drives (or other similar type of storage medium). The data store 106 may be included in the example computing system 100 as shown, or, in another example, the data store 106 may be remote from and communicatively coupled to the computing system 100 such as via a network. The data store 106 may also be a collection of multiple data stores. In one example, the data store 106 may be an entire data store server or a collection of data store servers configured to store large amounts of data.

The account module 108 may be configured to maintain and manage user accounts. For example, the account module 108 may allow a new user to register an account on the computing system 100 such as through an interface. The account module 108 may also determine whether a user's account has expired, for example, because the user has failed to maintain or pay for the account. If the account module 108 determines that the account has expired, the account module 108 may alert the compaction module 110.

Additionally, users of the computing system 100 may upload or modify the users' data to the data store 106 through the account module 108. Each user's data may be associated with that user's account. In addition to uploading data, the users may modify existing data or remove data. Data may also be automatically uploaded or modified based on the users' preferences.

If the account module 108 alerts the compaction module 110 that a user's account has expired, the compaction module 110 may begin to compact the data associated with the expired account based on data content. In one example, the compaction process may begin automatically, or, alternatively, the compaction process may be triggered by a user, after a certain period of time has passed, or by a specific event. Although several example compaction processes will be described herein, they should not be seen as limiting but merely as illustrative of the varying types of compaction processes possible.

One example of the compaction process performed by the compaction module 110 includes converting audio files into text files. In one example, audio files containing music may simply be deleted instead of being converted. Once the audio files are converted into text files, the original audio files may be deleted by the compaction module 110 while the newly-created text files may be retained in data store 106. In this example, the compaction process preserves the content of the audio files as text files while significantly reducing the storage space needed for storing the content.

In another example of the compaction process performed by the compaction module 110, the compaction module 110 may convert video files from a higher quality/resolution into lower quality/resolution video files through compression techniques. Once the video files are converted into a lower quality/resolution, the original video files may be deleted by the compaction module 110 while the newly-created lower quality/resolution video files may be retained in data store 106. In this example, the compaction process preserves the content of the video files while significantly reducing the storage space needed for storing the content.

In another example of the compaction process, the compaction module 110 may convert files containing text, such as Microsoft Word files, Office Open XML files, Portable Document Format files, hypertext markup language files, extensible markup language files, etc. into plain text files. The compaction process may remove formatting, images, and other information while maintaining the textual content of the files. Similar compaction processes may be performed for other types of files including spreadsheet files, presentation files, etc.

In yet another example of the compaction process, the compaction module 110 may strip compound files such as zip files, personal storage table files, etc. into the individual files contained in the compound files. Each of the individual files may be further compacted based on each file's content, as disclosed herein. For example, if a personal storage table file is present, it may be stripped down to its individual electronic mail messages. The compaction module 110 may delete any attachments to the individual electronic mail messages while retaining the content of each of the individual electronic mail messages.

In some implementations, the compaction module 110 may scan the contents of each individual file stored in the data store 106 and associated with a user's account in order to segregate certain files based on their content. Compaction may be performed depending on the content of each file. For example, any file determined to contain medical information may be saved without being altered while any non-medical files may be permanently deleted or otherwise compacted. Similarly, any files determined to contain legal information may be similarly saved without being altered while any non-legal files may be permanently deleted or otherwise compacted. Any type of content may be scanned for, including key words, categories, or other indicia, and may be used in applying the appropriate compaction processes. Once the files are determined by their content, the files may be segregated by content type. In this way, the files may be stored in different data stores based on content type. Additionally, certain content file types may be deleted, unaltered, or otherwise treated differently from other content types.

The compaction module 110 of the example computing system 100 may utilize any appropriate number of the different compaction processes described herein, either alone or together in any appropriate combination. The different compaction processes may be performed simultaneously, consecutively, or in intervals over a period of time. Once the compaction module 110 completes the compaction process(es), the remaining data may be stored in data store 106 (or in another data store), and the original data may be deleted.

The example computing system 100 may also include a policy module (not shown) to enable an administrative user of the computing system 100 to customize the compaction module. The policy module may enable the administrative user to select from preconfigured compaction policies, create a new compaction policy, or modify an existing compaction policy.

In one example, the administrative user may select a compaction policy through the policy module that detects all audio files. As discussed above, once the audio files are detected, the audio files containing music may be deleted while the audio files containing voice audio may be compressed or converted to a different audio file type, quality, or size. In another example, the administrative user may select a compaction policy through the policy module that detects all video files. Once the video files are detected, the video files may be reduced in quality. These are only examples of policies that may be utilized, and it should be understood that other policies, or combinations of policies, could be utilized, as described herein. In an example computing system 100 without the policy module, a preconfigured compaction policy may be included.

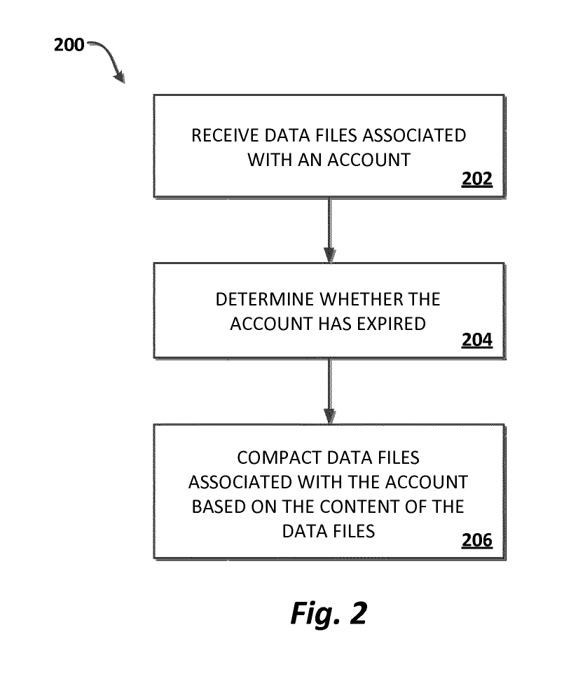

FIG. 2 illustrates a method 200 of compacting data based on data content according to examples of the present disclosure. The method 200 may be performed by the computing system 100, for example, or on another suitable device. The method 200 may include receiving, at a computing device, data files associated with an account (block 202); determining, by the computing device, whether the account has expired (block 204); and in response to determining that the account has expired, compacting, by the computing device, the data files associated with the account based on the content of the data files (block 206). Additional processes also may be included, and it should be understood that the processes depicted in FIG. 2 represent generalized illustrations, and that other processes may be added or existing processes may be removed, modified, or rearranged without departing from the scope and spirit of the present disclosure.

At block 202, the computing device may receive data files associated with a user account. For example, a user may upload files to the computing device manually, or automated back-up of the users file may occur.

At block 204, the computing device may determine whether the user account has expired. If the account has not expired, the user may be permitted to continue to use the account, including backing up data to the account and retrieving data from the account. If, however, the account has expired, the user may be prevented from using the account without reactivating the account. Reactivating the account may include payment of a fee or some other action.

If the computing device determines that the account has expired, the data files associated with the account may be compacted at block 206. As described herein, this may include determining the content or type of the data files and performing various compaction processes depending upon the content of the data (or the data file types). For example, audio files may be converted into text files, video files may be compressed to lower quality/resolution files, attachments may be stripped from email, and/or files containing certain types of content may be preserved as-is without any compaction, as described herein.

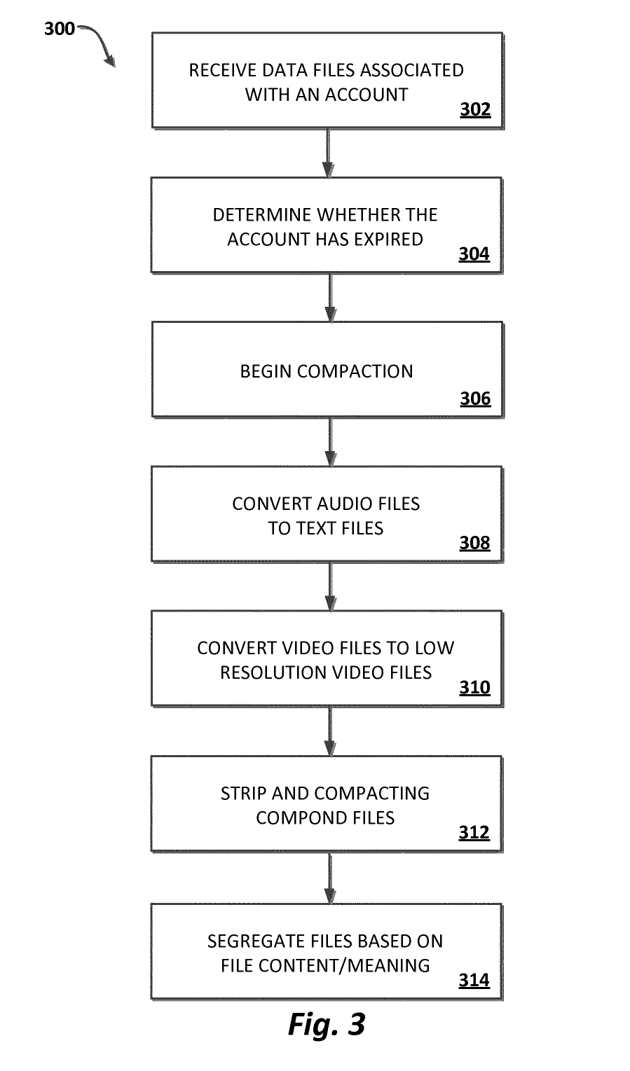

FIG. 3 illustrates a method 300 of compacting data based on data content according to examples of the present disclosure. The method 300 may be performed by the computing system 100, for example, or on another suitable device. The method 300 may include receiving, at a computing device, data files associated with an account (block 302); determining, by the computing device, whether the account has expired (block 304); in response to determining that the account has expired, beginning the compacting process, by the computing device (block 306); converting audio files to text files (block 308); converting video files to low resolution video files (block 310); stripping and compacting compound files (block 312); and segregate files based on meaning (block 314). Additional processes also may be included, and it should be understood that the processes depicted in FIG. 3 represent generalized illustrations, and that other processes may be added or existing processes may be removed, modified, or rearranged without departing from the scope and spirit of the present disclosure.

At block 302, the computing device may receive data files associated with a user account. For example, user may upload files to the computing device manually, or automated back-up of the users file may occur.

At block 304, the computing device may determine whether the user account has expired. If the account has not expired, the user may be permitted to continue to use the account, including backing up data to the account and retrieving data from the account. If, however, the account has expired, the user may be prevented from using the account without reactivating the account. Reactivating the account may include payment of a fee or some other action.

If the computing device determines that the account has expired, the compaction process may begin at block 306. Beginning the compaction process may include an administrative user selecting one or more compaction processes from a predefined list, or the administrative user may create one or more new compaction processes. In the example method 300, it will be assumed that the administrative user selected the following compaction processes: converting audio files to text files (block 308); converting video files to low resolution video files (block 310); stripping and compacting compound files (block 312); and segregate files based on meaning (block 314). In other examples, different compacting processes may be utilized in varying orders and numbers.

In this example method 300 of compacting data based on data content, audio files may be converted to text at block 308. In one example, audio files containing music may be deleted. The converted text files may be saved to a data store for long-term storage while the original audio files may be deleted.

Continuing to block 310, video files may be converted from a higher quality/resolution to a lower quality resolution using compression techniques. Once the video files are converted into a lower quality/resolution, the original video files may be deleted while the converted lower quality/resolution video files may be saved to a data store for long-term storage.

At block 312, compound files may be stripped into their individual files. Each of these individual files may be compacted based on the compaction policy selected. For example, if a compound containing email messages is present, it may be stripped into the individual email messages. Then, based on the compaction policy, all attachments may be deleted while the email messages themselves may be saved.

At block 314, the files may be segregated based on the content or meaning of the files. For example, files containing medical information, files containing legal information, files containing personal or identifying information, and general files may all be segregated. This may be desired if laws or regulations require the retention or deletion of certain information. If the user decides to reactivate its account after the account expires, the user may be more interested in higher value data, such as data containing medical information or legal information, than general data, such as songs, general emails, and photos.

In some examples, it may be desirable to include delays between the compaction steps. In such cases, if a user decides to reactivate its account, all of the data might not yet have been compacted, allowing the user to receive some of its data in the original form.

It should be emphasized that the above-described embodiments are merely possible examples of implementations, set forth for a clear understanding of the principles of the present disclosure. Many variations and modifications may be made to the above-described examples without departing substantially from the spirit and principles of the present disclosure. Further, the scope of the present disclosure is intended to cover any and all appropriate combinations and sub-combinations of all elements, features, and aspects discussed above. All such modifications and variations are intended to be included within the scope of the present disclosure, and all possible claims to individual aspects or combinations of elements or steps are intended to be supported by the present disclosure.

What is claimed is:

1. A method comprising:
receiving, at a computing device, data files associated with an account;
determining, by the computing device, whether the account has expired; and
in response to determining that the account has expired, compacting, by the computing device, the data files associated with the account based on content of the data files.

2. The method of claim 1, further comprising:
determining, by the computing device, whether a first data file, from the data files associated with the account, can be compacted based on an analysis of the content of the first data file.

3. The method of claim 2, further comprising:
in response to determining that the first data file, from the data files associated with the account, can be compacted, compacting, by the computing device, the first data file that can be compacted; and
in response to determining that the first data file, from the data files associated with the account, cannot be compacted, deleting, by the computing device, the first data file that cannot be compacted.

4. The method of claim 1, further comprising:
segregating, on the computing device, the data files into groups.

5. The method of claim 1, further comprising:
receiving, on the computing device, the a compaction policy for compacting the data files from an administrative user.

6. The method of claim 1, further comprising:
storing, by the computing device, the compacted data files in a data store.

7. The method of claim 6, further comprising:
determining, by the computing device, that the expired account has been reactivated; and
in response to determining that the expired account has been reactivated, restoring, by the computing device, the compacted data files from the data store.

8. The method of claim 1, wherein compacting the data files associated with the account based on the content of the data files further comprises converting, by the computing device, an audio file into a text file representative of the audio contained in the audio file.

9. The method of claim 1, wherein compacting, by the computing device, the data files associated with the account based on the content of the data files further comprises converting data files containing higher-quality video into data files containing lower-quality video.

10. The method of claim 1, wherein at least one of the data files associated with the account is a collection of individual data files.

11. The method of claim 10, further comprising:
analyzing, by the computing device, the collection of individual data files; and
compacting, by the computing device, the collection of individual data files based on the content of the individual data files.

12. A system comprising:
one or more processors;
a memory for storing machine readable instructions;
a data store for storing data associated with an account;
an account module stored in the memory and executing on at least one of the one or more processors to determine whether the account has expired; and
a compaction module stored in the memory and executing on at least one of the one or more processors to compact the data stored in the data store based on content of the data in response to the account module determining that the account has expired.

13. The system of claim 12, further comprising:
a policy module stored in the memory and executing on at least one of the one or more processors to enable a user of the system to customize the compaction module.

14. A non-transitory computer-readable storage medium storing instructions that, when executed by one or more processors, cause the one or more processors to:
receive data files associated with an account;
determine whether the account has expired; and
compact the data files associated with the account based on content of the data files, in response to determining that the account has expired by causing the one or more processors to:
convert an audio file into a text file;
convert a higher-quality video file into a lower-quality video file;
strip a compound file into individual files; and
segregate the data files based on the content of the data files.

15. The computer-readable storage medium of claim 14, wherein the instructions further cause the processor to receive a compaction policy, wherein the compaction policy further comprises an audio file policy, a video file policy, a compound file policy, and a file segregation policy.
